(19) United States
(12) Patent Application Publication
(10) Pub. No.: US 2021/0365416 A1
(43) Pub. Date: Nov. 25, 2021

(54) MOUNT PARAMETER IN FILE SYSTEMS

(71) Applicant: Hewlett Packard Enterprise Development LP, Houston, TX (US)

(72) Inventors: Ravikumar Chilaka, Bangalore Karnataka (IN); Mohan Govindaraj, Bangalore Karnataka (IN)

(21) Appl. No.: 17/301,944

(22) Filed: Apr. 20, 2021

(30) Foreign Application Priority Data
May 25, 2020 (IN) 202041021867

(51) Int. Cl. G06F 16/182; G06F 16/14; G06F 16/13

(52) U.S. Cl. CPC G06F 16/1824; G06F 16/13; G06F 16/148

(57) ABSTRACT

Aspects pertaining to a distributed file system are described. In an example, system call is made by a server computing device on receiving a request for accessing a file, by a client device operating on a first computing architecture. A mount parameter is received in response to the system calls, wherein the mount parameter is to prescribe a computing architecture of a computing device to access the file system. Attribute information pertaining to the file to be accessed may thus be modified on determining the mount parameter to prescribe a first computing architecture for the client device, wherein modified attribute information is of a bit-size conforming to the first computing architecture.

### BACKGROUND

A distributed file system is a file system based on a client/server architecture. The distributed file system allows several client devices to access and process data, such as files, stored in hierarchical manner within central file systems. Example of the distributed file system includes, but is not limited to, Network file System (NFS). For example, the central file systems may be implemented as Physical File Systems (PFS) within the NFS based distributed file systems. In an event of a request by a client device for access to a file stored in a central file system, attribute information of the file is retrieved and retained by a server computing device. To such end, the attribute information may be transmitted to the client, wherein the client processes the attribute information to access the file. In some cases, the client may fail to process the attribute information of the file. The failure may prevent the client from accessing the file stored in the central file system.

### BRIEF DESCRIPTION OF FIGURES

Systems and/or methods, in accordance with examples of the present subject matter are now described, by way of example, and with reference to the accompanying figures, in which:

FIG. 1 illustrates a server computing device for handling a request from a client device, as per an example;

FIG. 2 illustrates a distributed file system environment for handling a request for accessing a file, as per an example;

FIG. 3 illustrates a call flow diagram of various computational entities within a distributed file system, as per an example;

FIG. 4 illustrates a method for handling system calls from a server computing device, as per another example; and

FIG. 5 illustrates a system environment implementing a non-transitory computer readable medium for handling a request from a client device, as per an example.

### DETAILED DESCRIPTION

The present subject matter relates to handling requests from a client application by a server computing device within a distributed file system. The distributed file system provides a mechanism which may allow certain applications implemented on client computing devices to access files stored within file systems, over a network. An example of such a distributed file system includes, but is not limited to, Network File System (NFS). In an NFS-based distributed file system, the file may be stored and managed by a Physical File System (PFS) and the server computing device may be an NFS server. The PFS may, in an example, be any logical layer which manages and undertakes certain disk related operations. For instance, the PFS may process physical blocks being read from or written onto the disk storage.

As is understood, a distributed file system may include a number of client computing devices communicatively coupled to a server computing device. The client device, through an application for example, may seek to access a file stored and managed by a file system within the distributed file system. The request to access the file may be passed onto the server computing device, which may then pass such a request to the file system. Based on the request, the file system may provide a response to the server computing device, which may be provided to the client device, or the application executing on the client device. Examples of the client device include, but are not limited to, mobiles, desktop computers, laptops, tablets and the like. Further, the server computing device may be a remote server.

Before any operation may be performed on the file stored in file system through the server computing device, a corresponding file identifier may have to be obtained. Such a file identifier may be subsequently used as a basis for communication between the server computing device and the client device. In a similar manner, information relating to other attributes of the file and the file system may also be exchanged before any file related operation may be performed. Such attribute information may be obtained through system calls initiated by the server computing device and transmitted to the file system. Example of information pertaining to attributes of the file include index node (inode) number, size, permissions, availability, accessibility, file owner, file group id, file user id, file n_link, status, and so forth. On the other hand, examples of file system attributes include file system type, file system block size, total number of blocks, blocks free, blocks used, total files, free files, flags and unused f_spare long type array.

In response to such system calls, the attribute information may be provided by the file system to the server computing device. The attribute information which may include the inode number for the file to which access is sought, may then be passed to the client device by the server computing device. The bit-size of the attribute information provided to the server computing device and subsequently provided to the client device, may depend on the computing architecture of the file system or the server computing device. For example, if the file system and the server computing device are 64-bit systems, then attribute information, such as the inode number returned by the file system, will be of 64-bit size. Such information may be passed onto the client device for further processing.

However, in certain cases it is possible that the client device may have a different computing architecture. For example, the client device may be based on a 32-bit architecture, in which case it may not be able to process the 64-bit attribute information or the inode number of the file, received from the server computing device. This will result in an error and prevent access to the file within the file system. Such an error may also occur even if the attribute information pertaining to the file are 32-bit in size. In certain instances, even though the inode number is 64-bit in size, certain attribute information may be 32-bit in size. As a result, even though attribute information is processable, an error will still occur since the inode number returned by the file system (and eventually the server computing device) will be 64-bit in size. This may further denies access to the file within the file system.

Such an issue may be resolved by adapting the server computing device such that the server computing device may return only 32-bit inode numbers. This may not always be efficient, since the client device communicating with the server computing device may be 64-bit systems, in certain implementations. In such cases, irrespective of the architecture of the client device, the server computing device will be configured to provide only 32-bit inode number for the file. This may impact other applications that may be communicating with the server computing device. Furthermore, such approaches involve making modifications to the kernel of server computing device. Such modifications are generally not preferred.

Examples of handling requests from client devices operating on a first computing architecture by a server computing device operating on a second computing architecture, are described. In the context of the present subject matter, a client device is capable of processing information of a first bit-size corresponding to the first computing architecture. Such a client device may process information received from the server computing device that processes information of a second bit-size corresponding to the second computing architecture. The client device may be in communication with the server computing device, with the server computing device being further supported by a file system. The server computing device and the file system may be based on the second computing architecture. In an example, the client device operating on first computing architecture has a bit-size less than the bit-size of the second computing architecture. For example, the first computing architecture may be a 32-bit architecture, while the second computing architecture may be a 64-bit architecture. Certain other approaches are also described with reference to the 32-bit and the 64-bit computing architecture, as an example, and are not to be construed as a limitation.

In certain cases, the file system may have to be mounted on the server computing device before files of the file system may be accessed. The file system, along with the files, may store attribute information pertaining to such files and pertaining to the file system. Further, the server computing device may provide all or a portion of attribute information pertaining to the file and the file system, to the client device in response to the request.

Returning to the present example, on initiating the mounting of the file system, an initial determination may be made to ascertain whether the file system under consideration will be accessed by a computing device operating on 32-bit computing architecture (referred to as a 32-bit system) or a 64-bit computing architecture (referred to as a 64-bit system). Such an assessment may be made by a system administrator (such as the server computing device) implementing the distributed file system. In an example, this may be defined by way of a mount parameter. The mount parameter indicates whether the file system under consideration is to be accessed by a 32-bit system or by a 64-bit system. In the context of NFS, the mount parameter may be defined in a Virtual File System (VFS) data structure, or as metadata corresponding to the file system.

With the mount parameter defined and the file system mounted, the server computing device and the file system may now handle request from the client device. In operation, the server computing device may initially receive a request for accessing a file within the file system, from the client device. In response to the request, the server computing device may make system calls onto the file system to obtain attribute information relating to the file and the file system. The file system may accordingly provide the requested information, in response to the system calls from the server computing device. In an example, the attribute information may include the inode number of the file.

While providing the attribute information, the file system may retrieve a value of the mount parameter defined at the time of mounting the file system. Once retrieved, the mount parameter may further be provided as a field in a data structure, and passed to the server computing device. In the context of NFS or Unix-based systems, the server computing device may make getattr and statfs system calls to obtain attribute information from the file system. In response to the statfs call, the file system may provide the mount parameter within an unused field of, for example, kstatfs data structure. In an example, the mount parameter may be specified in an unused f_spare field. Further, the file system may provide other attribute information pertaining to the file system within certain prescribed fields of the kstatfs data structure. In a similar manner, in response to the getattr call, the file system may provide attribute information pertaining to the file within prescribed fields of, for example, kstat data structure.

Returning to the present example, based on the response received from the file system, the server computing device may determine whether the file system is to handle requests from a 32-bit system or from a 64-bit system. In the event that the mount parameter (for example, as indicated in the f_spare field) indicates that the file system may handle requests from a 64-bit system, no further action may be taken. In such case, the server computing device may provide the received attribute information including the inode number of the file to the client device, without any modification thereto.

However, in the event that the mount parameter indicates that the file system is to handle requests from a 32-bit system, the server computing device may subsequently modify the attribute information, such as the inode number of the file (which is a 64-bit value as received from the file system). In an example, the server computing device may modify the inode number by masking or removing upper 32-bits of the inode number. The modified inode number along with the other attribute information of the file, file system and a file identifier may be passed to the client device, and accordingly access to the file may be provided. The server computing device may construct the file identifier. For example, the server computing device may cause to store the true 64-bit inode number for the file in the file identifier. In an example, the file identifier may be an opaque data structure and may only be processed by the server computing device. The server computing device may process the file identifier for identification of the file in consideration, during any future communication with the client device. In context of NFS based system, the file identifier may be a file handle.

The present subject matter discloses approaches for enabling the 32-bit client device to access the file stored in the 64-bit file system using the modified attribute information. Based on the approaches defined herein, the 32-bit client device may access the file based on modified inode number. In cases where attribute information of the file, other than the inode number, are within 32-bits value, the client device may access the file using the modified 32-bit inode number without encountering any error. In this regard, modified attribute information, that may be provided to a client device generating an initial request, may be provided to other client devices subsequently. As a result, the multiple client devices may access the file simultaneously, using the modified attribute information.

The above examples are further described in conjunction with appended figures. It should be noted that the description and figures merely illustrate the principles of the present subject matter. It will thus be appreciated that various arrangements that embody the principles of the present subject matter, although not explicitly described or shown herein, may be devised from the description, and are included within its scope. Moreover, all statements herein reciting principles, aspects, and examples of the present subject matter, as well as specific examples thereof, are intended to encompass equivalents thereof. In the figures, the left-most digit(s) of a reference number identifies the figure in which the reference number first appears. The same numbers are used throughout the figures to reference like features and components.

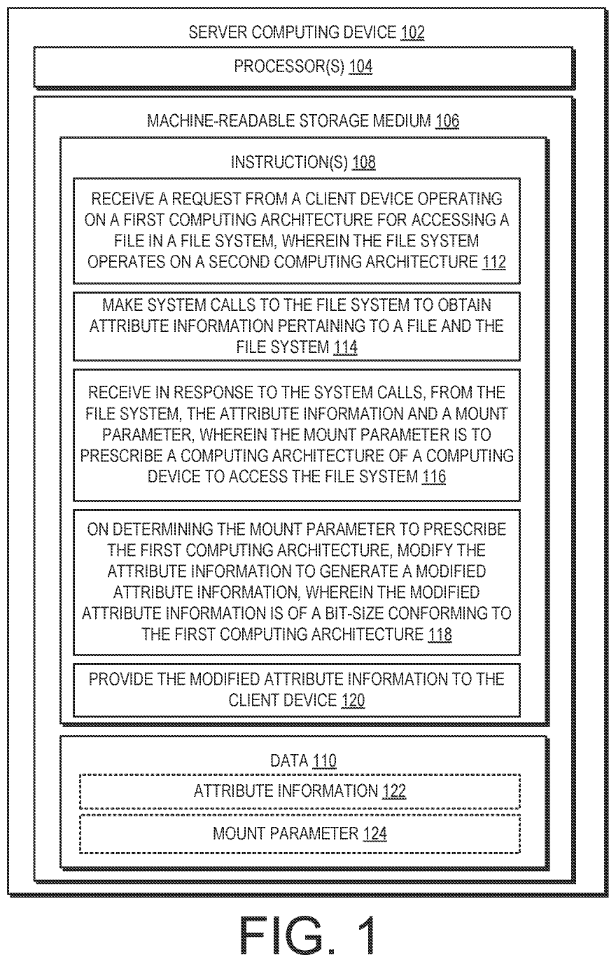

FIG. 1 illustrates a server computing device 102 for handling a request from a client device (not shown in FIG. 1), as per an example. The server computing device 102 includes processor(s) 104, and a machine-readable storage medium 106 coupled to and accessible by the processor(s) 104. The machine-readable storage medium 106 stores instruction(s) 108 and data 110, that is accessible by the processor(s) 104. The server computing device 102 may be implemented within a computing device or as a remote server. In an example, the server computing device 102 may be a computing device for processing and analyzing requests received from the client device, such as a client computing device or a client application executed on the client computing device. Although not depicted, the server computing device 102 may include other components, such as interfaces to communicate over the network with external storage or client devices, display, input/output interfaces, operating systems, applications, and the like, which have not been described for brevity.

The processor(s) 104 may be implemented as a dedicated processor, a shared processor, or a plurality of individual processors, some of which may be shared. The machine-readable storage medium 106 may be communicatively connected to the processor(s) 104. Among other capabilities, the processor(s) 104 may fetch and execute computer-readable instructions 108 (referred to as instruction(s) 108), stored in the machine-readable storage medium 106. The machine-readable storage medium 106 may include any non-transitory computer-readable medium including, for example, volatile memory such as RAM, or non-volatile memory such as EPROM, flash memory, and the like.

Within a networked environment comprising a distributed file system, the server computing device 102 may be coupled to a file system (not shown in FIG. 1). The file system may include a logical mechanism implemented through computing devices for accessing and managing files stored in a disk storage, and may be implemented on a processor-based computing device. The access to the files stored in the disk storage may be implemented through metadata (such as, attribute information) relating to the files. In an example, the server computing device 102 and the file system may be implemented within a distributed file system protocol, for example, NFS. In case of an NFS-based distributed file system, the file system may be a physical file system (PFS) and the server computing device 102 may be an NFS server. Further, the NFS based distributed file system may include a virtual file system (VFS) layer in order to route system calls, or communications from the NFS server, such as the server computing device 102, to the file system.

In operation, the processor(s) 104 may fetch and execute instruction(s) 108 to process the request received from the client device for accessing the file. In an example, the instruction(s) 108 may include instructions 112 to receive the request from the client device, such as a request for accessing a file stored in the file system. In the present example, the client device may be operating on a first computing architecture, and the server computing device 102 and the file system may be operating on a second computing architecture. The computing architecture for a computing device may correspond to a bit-size of information processable by the computing device. In the present case, therefore, the client device may handle and process information having a first bit-size, whereas the server computing device 102 along the file system may handle and process information having a second bit-size. As an example, the first computing architecture may be a 32-bit architecture and thus the client device may be capable of processing 32-bit sized information. In a similar example, the second computing architecture may be a 64-bit architecture, with the server computing device 102 capable of processing 64-bit sized information.

Continuing further, the instruction(s) 108 may include instructions 114 to cause to make system calls to the file system to obtain attribute information 122 pertaining to the file and the file system. Examples of the attribute information pertaining to the file includes index node (inode) number, availability, accessibility, size, file owner, file group id, file user id, file n_link, status, and permissions. On the other hand, attribute information pertaining to the file system includes file system type, file system block size, total blocks, blocks free, blocks used, total files, files free, and an unused long f_spare array.

In response to making the system calls on the file system, the instructions 116 may further be executed to receive the attribute information and information indicating the mount parameter, which may be stored as attribute information 122 and mount parameter 124, respectively. As described previously, the attribute information 122 may include information pertaining to the file system and the file to be accessed by the client device. In an example, the attribute information 122 includes file attribute information and file system attribute information. In an example, file attribute information is returned within file attribute structure, with the file system attribute information and the mount parameter 124 being provided in a file system attribute structure. On the other hand, the mount parameter 124 may indicate whether the file system under consideration is to be accessed by a computing device that is a 32-bit system or a 64-bit system.

The mount parameter 124 thus received from the file system may be further processed by the server computing device 102 to ascertain whether the mount parameter 124 specifies a first computing architecture or a second computing architecture. As mentioned above, if the file system is to receive and process requests from a system based on first computing architecture or a second computing architecture, the mount parameter 124 will indicate so accordingly.

Proceeding further, the instructions 118 may be executed to modify the attribute information to generate a modified attribute information in response to determining that the mount parameter 124 prescribes a first computing architecture. For example, the mount parameter 124 may indicate that the file system is to service requests from a client (such as the client device) which is a 32-bit system. In such a case, the server computing device 102 may modify the attribute information 122 to provide modified attribute information which is 32-bit in size. In an example, the server computing device 102 may mask a portion of the attribute information 122, such that the resulting modified attribute information is of a bit-size which conforms with the first computing architecture.

Thereafter, the processor(s) 104 further executes instructions 120 to provide the modified attribute information to the client device. The modified attribute information may include, but are not limited, modified inode number, file identifier and other attribute information of the file and the file system. Further, the server computing device 102 may cause to store the true 64-bit inode number of the file in the file identifier. In one example, the file identifier may be an opaque file handle.

In the manner as described above, the request may be handled by the server computing device 102 to enable the client device to access the file. It may be noted that above approaches are provided in conjunction with few examples. However, the scope of the present subject matter should not be restricted to only said examples. The other examples and additional aspects are further described in conjunction with the remaining figures.

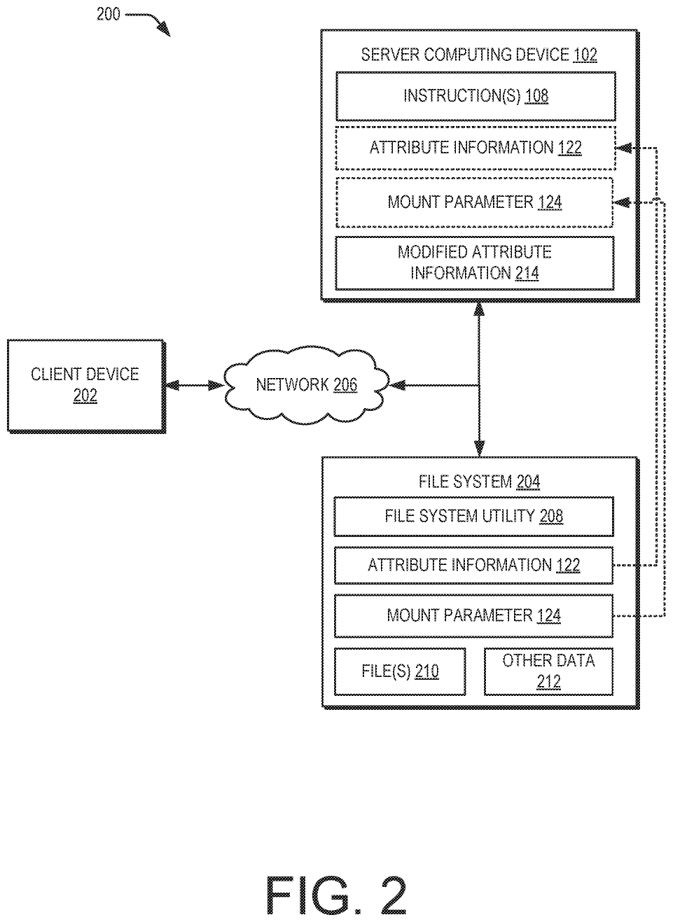

FIG. 2 illustrates a distributed file system environment 200 for handling a request for accessing a file, as per an example. The environment 200 includes a server computing device 102 coupled to a client device 202. The client device 202 may make request for accessing the file which may be stored in a file system 204 through the server computing device 102. The server computing device 102 consequently handles the request received from the client device 202 and provides access to the requested file.

The server computing device 102, the client device 202, and the file system 204 may be communicatively coupled to each other via network 206. The network 206 may be a private network or a public network and may be implemented as a wired network, a wireless network, or a combination of a wired and wireless network. The network 206 may also include a collection of individual networks, interconnected with each other and functioning as a single large network, such as the Internet. Examples of such individual networks include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), Long Term Evolution (LTE), and Integrated Services Digital Network (ISDN).

The server computing device 102 may include instruction(s) 108 for performing operations associated with the server computing device 102. In an example, the instruction(s) 108 are fetched from a machine-readable storage medium and executed by a processor included within the server computing device 102 to cause the server computing device 102 to perform the various functions as described. Pursuant to the present subject matter, the instruction(s) 108 may be fetched and executed on receiving the request from the client device 202 for accessing the file. The instruction(s) 108 may be executed by the processor of the server computing device 102 to handle the request and provide attribute information 122 to the client device 202, pertaining to the file for which access is sought.

The file system 204 on the other hand may include file system utility 208, which when executed cause the client device 202 to perform certain functions in response to system calls from the server computing device 102. In an example, a system administrator may prescribe a mount parameter 124 value to the file system 204. In an example, the mount parameter 124 may serve to indicate the computing architecture of a computing device which would be served by the file system 204. For example, the mount parameter 124 may be set to indicate that the file system 204 may serve either a 32-bit or a 64-bit client device (e.g., the client device 202). In an example, mount parameter 124 may be stored within a VFS data structure or metadata of the file system, i.e., the file system 204.

In an example, the client device 202 may be operating on a first computing architecture, whereas the server computing device 102 and the file system 204 may be operating on a second computing architecture. The present example is now described with respect to the client device 202 being a 32-bit system, while the server computing device 102 and the file system 204 being 64-bit systems. As may be understood, the client device 202 operating on 32-bit computing architecture may handle and process 32-bit sized information. In a similar manner, the server computing device 102 and the file system 204, operating on the 64-bit computing architecture may handle and process 64-bit sized information. Other combinations may also be relied on without deviating from the scope of the present subject matter.

Continuing further with the present example, the server computing device 102 may receive the request for accessing the file stored in the file system 204. The request generated by the client device 202 may include a file name for the file for which access is sought. On receiving the request from the client device 202, the instruction(s) 108 may be executed to cause the server computing device 102 to make system calls to the file system 204. In an example, the system calls from the server computing device 102 are to obtain certain information pertaining to the file (for which access is sought by the client device 202) and the file system 204. Such information, referred to as attribute information 122, forms the basis on which the server computing device 102 (and in turn the client device 202) may access the file stored onto the file system 204. In the context of an NFS based distributed file system, the system calls from the server computing device 102 may include a getattr call and a statfs call. It may be noted that the present example of system call is only indicative, and that other types of system calls (corresponding to their respective distributed file systems) may be used without limiting the scope of the present subject matter.

On receiving the system calls from the server computing device 102, the file system utility 208 of the file system 204 may retrieve attribute information 122 and accordingly prepare a response to the system calls from the server computing device 102. Examples of the attribute information 122 may include, but is not limited to, file system attribute information and file attribute information. Other information may also be a part of the attribute information 122, without deviating from the scope of the present subject matter. Once the attribute information 122 is retrieved, file system utility 208 may generate a data structure, and write the retrieved attribute information 122, therein. In an example, the attribute information 122 may include an inode number of the file for which access is requested. The file system 204 may store file(s) 210 and other data 212, wherein the file(s) 210 may include the file for which access is sought.

Returning to the present example, the server computing device 102 may subsequently determine whether the file system 204 is to service requests from a client device (such as the client device 202) operating on a 32-bit or a 64-bit computing architecture. In an example, the server computing device 102 may do so, based on the value provided in the mount parameter 124. In an example, the mount parameter 124 may be provided in unused f_spare field of a data structure corresponding to statfs call.

The functions thereafter performed by the server computing device 102 may differ based on the value of the mount parameter 124. For example, on determining that the file system 204 is to service a 64-bit client device 202, the server computing device 102 may pass the 64-bit sized attribute information 122 (including the inode number of the file) to the client device 202. However, on determining that the file system 204 is to service a 32-bit client device 202, the server computing device 102 may accordingly modify the attribute information 122.

As may be understood, the inode number of the file returned by the file system 204 in response to the system calls will be a 64-bit value (since the file system 204 is a 64-bit system). Since the client device 202 is a 32-bit system, it would not be able to process, compile or decode the 64-bit sized attribute information 122 received from the file system 204. To such an end, the instruction(s) 108 within the server computing device 102 may be executed to modify the 64-bit inode number to provide modified attribute information 214. The modified attribute information 214 is such that it is of a bit-size that conforms to the computing architecture of the client device 202 (i.e., the first computing architecture). For example, the server computing device 102 may modify the attribute information 122 (which is 64-bit, in size) such that the modified attribute information 214 is 32-bit in size. In an example, the server computing device 102 may modify the attribute information 122 by either masking or removing upper 32-bits from the 64-bit attribute information 122 to provide the modified attribute information 214. In another example, it may be the case that the inode number of the file to be accessed is 64-bit in size, while the remaining attribute information 122 is 32-bit in size. In such a case, the server computing device 102 may modify the inode number by removing upper 32-bits of the true 64-bits inode number. The modified 32-bit inode number is such that it is processable by the client device 202 (which is a 32-bit system).

Returning to the present example, the server computing device 102 provides the modified attribute information 214 that includes the modified inode number along with other attribute information of the file and the file system, to the client device 202. The modified attribute information 214 provided by the server computing device 102 may also include a file identifier, wherein the true 64-bit inode number for the file may be stored within the file identifier. In an example, the file identifier may be an opaque file handle that may only be processed, such as decoded, by the server computing device 102. The client device 202, on receiving the modified attribute information 214 may process the modified attribute information 214. Accordingly, access to the file is provided to the client device 202 based on the modified attribute information 214.

Furthermore, the server computing device 102 may process the file identifier for identification of the file in consideration, during any future communication from the client device 202 pertaining to the file. In this regard, the file identifier is returned to the server computing device 102 with the communication, from which the server computing device 102 may extract the true 64-bit inode number of the file to identify the file and further communicate with the file system 204.

In one example, the server computing device 102 may receive a second request for access to the file, from a second client device (not illustrated in FIG. 2) which may be operating on a second computing architecture (i.e., a 64-bit computing architecture). In such a case, the second client device would be capable of processing 64-bit sized information or less. As a result, second client device would be capable of processing the modified attribute information 214 (which is 32-bit in size), without impacting its functioning. In such a manner, different client devices which may be operating on different computing architectures may be efficiently supported by the file system 204 and the server computing device 102.

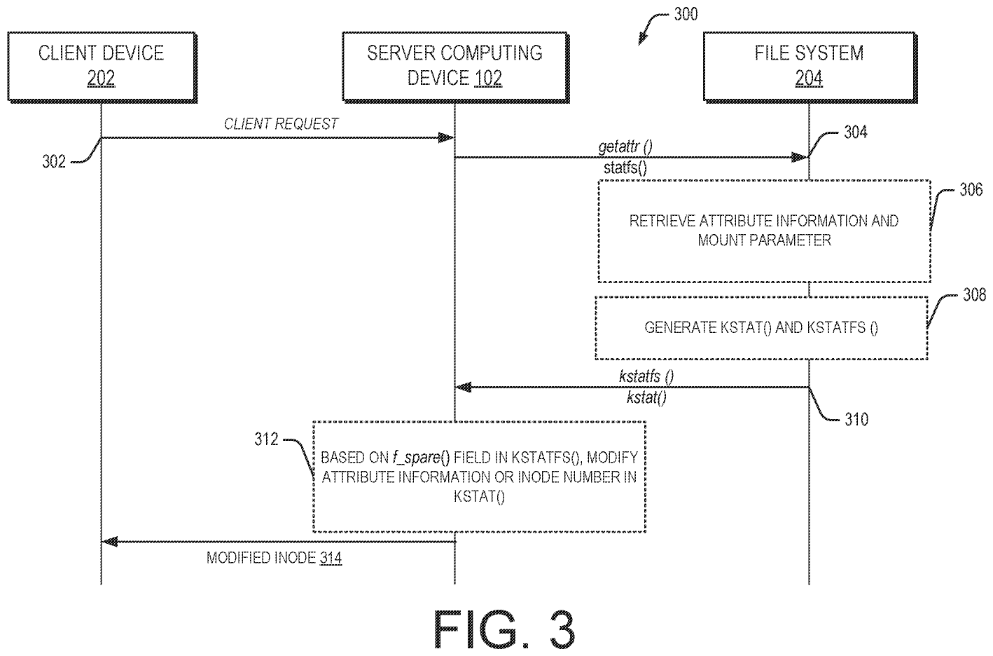

FIG. 3 illustrates an example call flow diagram of various computational entities within a distributed file system 300, as per one example. Within the distributed file system 300, a client device 202, server computing device 102 and the file system 204 may be interacting with each other (e.g., through a network 206). In the present example, the client device 202 is operating on a 32-bit computing architecture, whereas the server computing device 102 and the file system 204 are operating on a 64-bit computing architecture. The call flow diagram depicts the interaction between the different computing entities as steps. The order in which such steps is described is not intended to be construed as a limitation, and some of the described method blocks may be combined in a different order to implement the method, or alternative method. Furthermore, other steps although not depicted, may also be present without limiting the scope of the present subject matter.

The present example has been explained in the context of the distributed file system 300 being a Network File System (NFS). In the NFS based distributed file system, the server computing device 102 may be an NFS server. In an example, the file system 204 may further include Virtual File System (VFS) Layer and a Physical File System (PFS). The VFS layer, amongst other things, may provide an interface between the server computing device 102 and the PFS. Furthermore, the NFS discussed herein may be implemented on Unix or Linux based operating system.

While implementing the file system 204, a system administrator may determine that the file system 204 is to be accessed by the client device 202 (which is a 32-bit). To such an end, the system administrator may define a mount parameter 124. The value of the mount parameter 124 may so be prescribed such that it indicates that the file system 204 is to service the client device 202. In an example, the value of the mount parameter 124 may be provided in the VFS data structure of the file system 204.

Initially, the client device 202 may initiate a client request for accessing the file, which may be stored within the file system 204. In an example, the client request may include certain file identifier which may identify a parent directory within the file system 204, and file name of the file for which access is sought. This is depicted as step 302. It is to be noted, the parent directory may be implemented as a table of content in which file name of files in the file system may be associated with corresponding inode number.

Once the client request is received by the server computing device 102, the server computing device 102 may make certain system calls onto the file system 204. For example, the server computing device 102 may make getattr call and statfs call to the file system 204. This is represented as step 304. As may be understood, the getattr call is to request for attribute information of the file (for which access is sought). Examples of such attributes include, but are not limited to, type of file (whether file or directory), permissions, inode number of the file, and size of file. On the other hand, the statfs call is to request for attribute information indicating the status or the state of the file system 204. Examples of such attributes include but are not limited to, amount of available space, or optimal size for transfer. It may be noted that the list of the attributes is only indicative. Other attributes may also be returned in response to the getattr call and statfs call, without deviating from the scope of the present subject matter. In an example, the getattr call and the statfs call may be implemented and responded to by the VFS layer of the file system 204. In such cases, the NFS may make a vfs_getattr call and vfs_statfs call to get attribute information of pertinent file within the file system 204 and the attribute information of pertinent file system 204.

Once the system calls from the server computing device 102 are received, file system utility 208 may retrieve the appropriate information (which is to be returned in response to the getattr call and the statfs call) along with the mount parameter 124. In an example, the file system utility 208 may retrieve the mount parameter 124 from the VFS data structure of the file system 204. For example, the mount parameter 124 may be defined by the system administrator, at a time of mounting of the file system 204. The mount parameter 124 may be stored along with pertinent file system attribute information. Additionally, the file attribute information along with the file system attribute information may then be stored as attribute information 122 within the file system 204. The retrieval of the attribute information 122 and the mount parameter 124 is performed at step 306.

Once retrieved, the file system utility 208 may generate data structures, and provide the attribute information 122 and the mount parameter 124 within the data structures. For example, file attribute information is populated within kstat data structure while the file system attribute information and the mount parameter are populated within kstatfs data structure. In an example, the kstat data structure includes a file attribute structure which is populated by the file system utility 208 with the file attribute information. In an example, the kstatfs data structure includes a filesystem attribute structure which is populated by the file system utility 208 with the file system attribute information. The kstatfs data structure may further include an unused field of the filesystem attribute structure. The unused field is populated with the mount parameter 124. In an example, the unused field is the f_spare field. In an example, the f_spare field may further include about eight elements. While specifying a value which corresponds to the mount parameter 124, the file system utility 208 may set any one or more of the eight elements of the f_spare field. The generation of the data structures such as, the kstat and kstatfs data structures to return the attribute information 122 and the mount parameter 124 is done at step 308.

Once the kstat and kstatfs data structures are generated, the same may be transmitted to the server computing device 102 in response to the system calls (i.e., the getattr call and the statfs call). As described in relation to the previous step, the kstat and the kstatfs data structures specify the attribute information 122. Moreover, the kstatfs data structure specifies the mount parameter 124 (indicated in the f_spare field). This occurs at step 310.

On receiving the kstat and kstatfs data structures, the server computing device 102 may retrieve the attribute information 122 and the mount parameter 124 from the respective fields of the corresponding data structures. On determining the mount parameter 124 (as specified in the f_spare field) to indicate that the file system 204 is to service a 32-bit client device 202, the server computing device 102 may modify the attribute information 122 to provide the modified attribute information 214 (depicted at step 312). In an example, the server computing device 102 may modify the inode number of the file (which will be a 64-bit sized information) to provide a modified inode number. The modified inode number is such that it is 32-bit in size. Since the modified inode number is 32-bit in size, the same would be processable by the client device 202. In an example, to modify the inode number, the server computing device 102 masks or removes upper 32-bits of the 64-bit sized inode number. Subsequently, the modified inode number of the file conform to the 32-bit computing architecture of the client device 202. For example, the server may retrieve the inode number of the file from data structure corresponding to the getattr call or the kstat data structure.

At step 314, the modified attribute information comprising the modified inode number is provided to the client device 202, in response to the request. The server computing device 102 also returns the file identifier provided by the client device 202 while raising the request. In an example, the server computing device 102 may cause to store the true 64-bit inode number of the file in the file identifier. As would be understood, the file identifier enables the server computing device 102 to identify the file during any future communication from the client device 202 pertaining to the file.

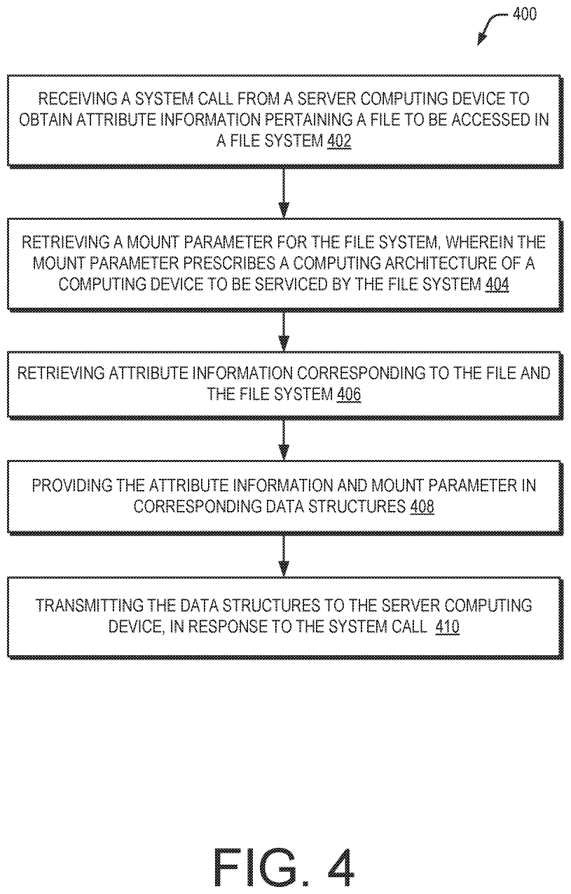

FIG. 4 illustrates example method 400 for handling systems call from a server computing device, as per an example. The order in which the above-mentioned methods are described is not intended to be construed as a limitation, and some of the described method blocks may be combined in a different order to implement the methods, or alternative methods.

Furthermore, the above-mentioned methods may be implemented in any suitable hardware, computer-readable instructions, or combination thereof. The steps of such methods may be performed by either a system under the instruction of machine executable instructions stored on a non-transitory computer readable medium or by dedicated hardware circuits, microcontrollers, or logic circuits. For example, the method 400 may be performed by the file system 204 in a distributed file system 300. Herein, some examples are also intended to cover non-transitory computer readable medium, for example, digital data storage media, which are computer readable and encode computer-executable instructions, where said instructions perform some or all of the steps of the above-mentioned method.

At block 402, system calls are received from a server computing device to obtain attribute information pertaining to a file to be accessed in the file system. For example, the system calls may be made by a server computing device 102 within the distributed file system 300. In an example, the system calls may include getattr call or statfs call. The systems calls may be received over a network 206, and may be in response to requests for accessing files in a file system 204 by a client device 202. In the present example, the client device 202 may be operating on a first computing architecture (e.g., a 32-bit computing architecture), while the server computing device 102 and the file system 204 may be operating on a second computing architecture (e.g., a 64-bit computing architecture).

At block 404, a mount parameter for the file system is retrieved. The mount parameter 124 is such that it prescribes a computing architecture of a computing device which may be serviced by the file system. In an example, the mount parameter 124 indicates whether the file system 204 under consideration, is to be accessed by a 32-bit system or by a 64-bit system. The mount parameter 124 may be initially defined by a system administrator during mounting of the file system 204. In an example, the mount parameter 124 may be specified in VFS data structure of the file system 204. In operation, the mount parameter 124 may be retrieved in response to the system calls (i.e., the getattr call and the statfs call) from the server computing device 102. In an example, the mount parameter 124 may be retrieved from the VFS data structure of the file system 204 by file system utility 208.

At block 406, attribute information corresponding to the file and the file system is retrieved. In an example, the file system utility 208 within the file system 204 may retrieve the attribute information 122 corresponding to the file and the file system 204. For example, the file attribute information may be stored as metadata of the file while the file system attribute information may be stored as metadata of the file system. The attribute information may include, for example, inode number, file size, file type, file object, blocks of file, file owner, file group id, file user id, file n_link, status and so forth.

At block 408, the attribute information and the mount parameter are provided in a data structure array. For example, the file system utility 208 may generate data structures, into which the attribute information 122 and the mount parameter 124 may be provided. In an example, the file attribute information may be provided in kstat data structure, which is generated in response to the getattr call from the server computing device 102. Further, the file system attribute information and the mount parameter 124 may be provided in kstatfs data structure, which is generated in response to the statfs call from the server computing device 102. The kstatfs data structure may include an unused field of the filesystem attribute structure. The unused field may be populated with the mount parameter 124. In an example, the unused field is the f_spare field. While specifying a value which corresponds to the mount parameter 124, the file system utility 208 may set a value within the f_spare field of the kstatfs data structure.

At block 410, the data structures are transmitted to the server computing device, in response to the system calls. For example, the kstat and kstatfs data structure generated by the file system utility 208 is transmitted to the server computing device 102 in response to the system calls (i.e., the getattr call and the statfs call). As described in relation to the previous step, the kstat data structure specifies file attribute information while the kstatfs data structure specifies the file system attribute information as well as the mount parameter 124 (indicated in the f_spare field). Based on the value of the mount parameter 124 as gathered from the f_spare field, the server computing device 102 may further modify the file attribute information (which would be a 64-bit sized information) to provide the modified attribute information 214 (which is 32-bit sized information). In an example, the server computing device 102 may modify a 64-bit sized inode number of the file to provide a modified inode number which is 32-bit in size. The server computing device 102 may modify the inode number by masking or removing a 32-bit sized portion of the inode number.

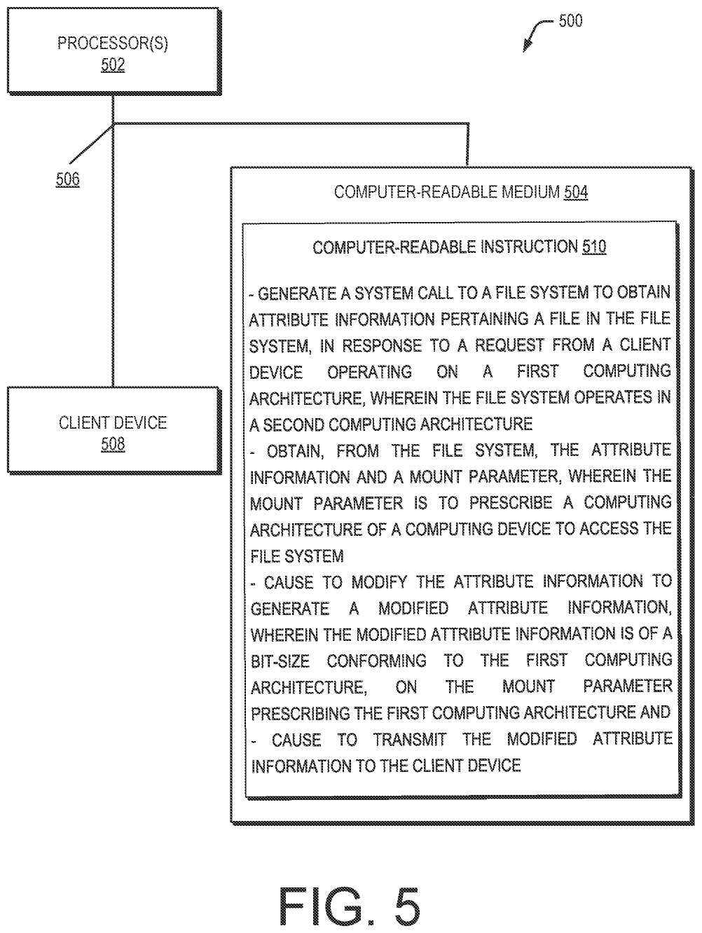

FIG. 5 illustrates a computing environment 500 implementing a non-transitory computer readable medium for handling request from a client device, for accessing a file. In an example implementation, the computing environment 500 may be for example, the distributed file system environment 200. In an example, the computing environment 500 includes processor(s) 502 communicatively coupled to a non-transitory computer readable medium 504 through a communication link 506. The processor(s) 502 may have one or more processing resources for fetching and executing computer-readable instructions from the non-transitory computer readable medium 504. The processor(s) 502 and the non-transitory computer readable medium 504 may be implemented, for example, in server computing device 102.

The non-transitory computer-readable medium 504 may be, for example, an internal memory device or an external memory device. In an example, the communication link 506 may be a direct communication link, such as any memory read/write interface. In another example, the communication link 506 may be an indirect communication link, such as a network interface. The communication link 506 may be a single network or a combination of multiple networks and may use a variety of different communication protocols.

The processor(s) 502 and the non-transitory computer-readable medium 504 may also be communicatively coupled to a client device 508 that generates the request for accessing a file stored in a file system. The client device 508 is such that it operates on a first computing architecture, whereas the device bearing the processor(s) 502 and the non-transitory computer-readable medium 504 may be operating on a second computing architecture. In an example, the first computing architecture is a 32-bit computing architecture, and the second computing architecture is a 64-bit computing architecture.

Referring to FIG. 5, in an example, the non-transitory computer readable medium 504 includes instruction(s) 510 that cause the processor(s) 502 to process request for accessing a file in a distribute file system, such as the distributed file system 300. In response to receiving the request from the client device 508, the instruction(s) 510, when executed, may generate system calls to the file system, such as file system 204, to obtain attribute information pertaining the file and the file system. The system calls may be made in response to the request from the client device 508. In an example, the system calls may be made using a getattr call and a statfs call.

The instruction(s) 510 upon execution may further obtain, from the file system, the attribute information and a mount parameter. The mount parameter (such as the mount parameter 124) may prescribe a computing architecture of a computing device which may be serviced by the file system (such as the file system 204). For example, the mount parameter 124 may indicate that the file system 204 may service requests from a client device, such as the client device 202, wherein the client device is a 32-bit system or a 64-bit system. In the context of an NFS, the mount parameter 124 may be provided in an unused field within a kstatfs data structure which is returned in response to the statfs call. In an example, the mount parameter may be specified in f_spare field of the data structure in the kstatfs data structure. Based on the value of the mount parameter, the instruction(s) 510 are executable to cause to modify the attribute information 122 to generate a modified attribute information, such as the modified attribute information 214. The modified attribute information is such that it is of a bit-size which conforms to the bit-size of information which may be handled and processed by client device 202 operating on first computing architecture. In an example, the instruction(s) 510 may be further executed to modify the 64-bit inode number to provide a modified 32-bit modified inode number. In another example, the instruction(s) 510 may cause modification of the 64-bit attribute information 122 or the inode number by masking an upper portion, for example, upper 32-bits of the inode number returned by the file system. The modified inode number may have a bit-size corresponding to the first computing architecture, such as 32-bits.

With the modified attribute information determined, the instruction(s) 510 upon execution may further cause to transmit the modified attribute information to the client device 508. In an example, the modified attribute information includes a file identifier, wherein the true inode number of the file may be stored within the file identifier. Thereafter, on receiving the modified attribute information, the client device 508 may access the file stored in the file system.

Although examples for the present disclosure have been described in language specific to structural features and/or methods, it should be understood that the appended claims are not necessarily limited to the specific features or methods described. Rather, the specific features and methods are disclosed and explained as examples of the present disclosure.

1. A server computing device comprising:
a processor; and
a machine-readable storage medium comprising instructions executable by the processor to:
receive a request from a client device operating on a first computing architecture for accessing a file in a file system, wherein the file system operates on a second computing architecture;
make a system call to the file system to obtain attribute information pertaining to the file and the file system;
receive in response to the system call, from the file system, the attribute information and a mount parameter, wherein the mount parameter is to prescribe a computing architecture of a computing device to access the file system;
on determining the mount parameter to prescribe the first computing architecture, modify the attribute information to generate a modified attribute information, wherein the modified attribute information is of a bit-size conforming to the first computing architecture; and
provide the modified attribute information to the client device.

2. The server computing device as claimed in claim 1, wherein the attribute information is returned in attribute structures, with the mount parameter being returned in an unused field of an attribute structure.

3. The server computing device as claimed in claim 2, wherein the unused field is an f_spare field in Network File System (NFS) based distributed file system.

4. The server computing device as claimed in claim 1, wherein to modify the attribute information, the instructions are executable to further:
obtain a file identifier from the attribute information;
derive an inode number of the file corresponding to the file identifier; and
mask a portion of the inode number to provide a modified inode number, such that the modified inode number is of a bit-size corresponding to the first computing architecture.

5. The server computing device as claimed in claim 4, wherein the instructions are executable to mask an upper portion of the inode number to provide the modified inode number.

6. The server computing device as claimed in claim 1, wherein the attribute information comprises a file identifier, an inode number, a file size, a file type, a file object, blocks of file, a file owner, a file group identifier, or a file user identifier.

7. The server computing device as claimed in claim 1, wherein the first computing architecture is a 32-bit computing architecture and the second computing architecture is a 64-bit computing architecture.

8. The server computing device as claimed in claim 1, wherein the system call comprises a getattr call or a statfs call in Network File System (NFS) based distributed file system.

9. A method comprising:
receiving a system call from a server computing device to obtain attribute information pertaining a file to be accessed in a file system;
retrieving a mount parameter for the file system, wherein the mount parameter prescribes a computing architecture of a computing device to be serviced by the file system;
retrieving attribute information corresponding to the file and the file system;
providing the attribute information and the mount parameter in corresponding data structures; and
transmitting the data structures to the server computing device, in response to the system call.

10. The method as claimed in claim 9, wherein the system call comprises a getattr call or a statfs call in Network File System (NFS) based distributed file system.

11. The method as claimed in claim 9, wherein the mount parameter is provided in Virtual File System (VFS) data structure of the file system.

12. The method as claimed in claim 11, the method further comprising:
retrieving the mount parameter specified in the VFS data structure; and
providing the mount parameter in an unused field of a data structure corresponding to virtual file system layer, returned in response to the system call.

13. The method as claimed in claim 12, wherein the unused field is an f_spare field in Network File System (NFS) based distributed file system.

14. The method as claimed in claim 9, wherein the mount parameter is provided at a time of mounting the file system.

15. The method as claimed in claim 9, wherein the computing device is to operate on a first computing architecture, and wherein the server and the file system are to operate on a second computing architecture.

16. The method as claimed in claim 15, wherein the first computing architecture is a 32-bit computing architecture and the second computing architecture is a 64-bit computing architecture.

17. A non-transitory computer-readable medium comprising computer-readable instructions being executable by a processing resource to:
generate a system call to a file system to obtain attribute information pertaining to a file and a file system, in response to a request from a client device operating on a first computing architecture, wherein the file system operates in a second computing architecture;
obtain, from the file system, the attribute information and a mount parameter, wherein the mount parameter is to prescribe a computing architecture of a computing device to access the file system;
cause to modify the attribute information to generate a modified attribute information, wherein the modified attribute information is of a bit-size conforming to the first computing architecture, on the mount parameter prescribing the first computing architecture; and
cause to transmit the modified attribute information to the client device.

18. The non-transitory computer-readable medium of claim 17, wherein the instruction to modify the attribute information, are to further:
obtain a file identifier from the attribute information;
derive an inode number from the file identifier; and
restrict size by masking an upper portion of the inode number to provide a modified inode number, such that the modified inode is of a bit-size corresponding to the first computing architecture.

19. The non-transitory computer-readable medium of claim 17, wherein the first computing architecture is a 32-bit computing architecture and the second computing architecture is a 64-bit computing architecture.

20. The non-transitory computer-readable medium of claim 17, wherein the system call comprises a getattr call or a statfs call in Network File System (NFS) based distributed file system.
